(19) United States
(12) Patent Application Publication
(10) Pub. No.: US 2020/0061725 A1
(43) Pub. Date: Feb. 27, 2020

(54) VEHICLE-MOUNTED WIRE SAW FOR CUTTING USED WIND TURBINE BLADES

(71) Applicant: GFSI GROUP LLC, Bothell, WA (US)

(72) Inventor: Don Lilly, Bothell, WA (US)

(73) Assignee: GFSI GROUP LLC, Bothell, WA (US)

(21) Appl. No.: 16/670,831

(22) Filed: Oct. 31, 2019

Related U.S. Application Data
(63) Continuation-in-part of application No. PCT/US2018/056948, filed on Oct. 22, 2018.
(60) Provisional application No. 62/753,832, filed on Oct. 31, 2018.
(60) Provisional application No. 62/575,295, filed on Oct. 20, 2017.

(51) Int. Cl. B23D 57/00; F03D 80/00

(52) U.S. Cl. CPC B23D 57/0069; B23D 57/0038; B23D 57/0053; F03D 80/00

(57) ABSTRACT

A method for using a vehicle-mounted wire saw for cutting an object (such as a wind turbine blade) includes coupling a wire saw having a continuous abrasive wire to a vehicle, engaging a wire tension to between about 100 PSI and about 5000 PSI, engaging a speed of an engine of the vehicle to between about 500 RPM and 4000 RPM, and cutting the object with the wire saw.

### BACKGROUND

Wind energy, and more specifically the use of wind turbines to generate electricity, is an exploding market. There are many companies producing blades for this growing number of turbines, and these blades need to be periodically replaced if they wear out or become damaged. This generates a problem for blade manufacturers, utilities, and other entities that may wish to keep decommissioned blades out of landfills. Although the prospect of recycling wind turbine blades may be attractive and consistent with the notion of wind energy as a “green” power source, it has not previously been technically or economically feasible. Despite previous efforts, experts have regarded wind turbine blades as “unrecyclable” and a problematic source of waste. See Liu et al., “Wind Turbine Blade Waste in 2050,” Waste Management, Vol. 62, pp. 229-240 (April 2017). With the growing importance of wind power in worldwide energy production, this problem will only get worse.

One obstacle is that if a potentially viable recycling process is proposed, wind turbine owners and manufacturers have no reliable way to verify which of the blades have been properly recycled and where the recycled material originated, among other obstacles.

The applicant has determined that these obstacles continue to inhibit the development of wind turbine blade recycling processes, partially because there is currently no system to efficiently track the status of blades after installation at a wind farm. Tracking the status of wind turbine blades in a recycling process is important for several reasons. For example, as suggested above, such a tracking system would allow turbine owners, utilities, or certification organizations to determine whether blades have been recycled properly and to correlate each recycled blade and its raw material that can be used for feedstock for various products. As another example, a tracking system would allow recyclers to adjust or redesign recycling processes to achieve further productivity and quality gains. In addition, when recycled blades are transformed into useful raw materials, the tracking system would provide manufacturers with additional intelligence to improve the productivity and quality of their manufacturing processes.

As a greater part of commercial and residential power is provided through renewable resources, the supply of used and no longer serviceable wind turbine blades has grown. Therefore, a need exists for methods to recycle the no-longer serviceable wind turbine blades, and other objects, and track the status of the recycling process accordingly.

A method using recycled fibrous resinous materials, such as fiberglass, in the production of products is disclosed in U.S. Pat. No. 9,028,731, fully incorporated herein expressly by reference.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a vehicle-mounted wire saw for cutting an object is provided. The vehicle-mounted wire saw generally includes a wire saw coupled to a vehicle and having a continuous abrasive wire; a wire saw feed pulley associated with the wire saw and configured to direct the continuous abrasive wire away from the wire saw; an opposing pulley positioned distal to the object from the wire saw, the pulley configured to receive and redirect the continuous abrasive wire from the wire saw feed pulley; and a wire saw receiving pulley associated with the wire saw and configured to receive the continuous abrasive wire from the opposing pulley and directing the continuous abrasive wire back to the wire saw feed pulley.

In accordance with any of the embodiments disclosed herein, the support frame assembly may further comprise a mobility system such that the vehicle-mounted wire saw is movable along the length of the object.

In accordance with any of the embodiments disclosed herein, the vehicle may be a skid loader.

In accordance with any of the embodiments disclosed herein, the vehicle mounted wire saw may further comprise a fluid source for applying fluid to the abrasive wire.

In accordance with any of the embodiments disclosed herein, the adjustment of the height of the wire saw may be through the loading system of the skid loader.

In accordance with any of the embodiments disclosed herein, the object may be a wind turbine blade.

In accordance with any of the embodiments disclosed herein, the wire saw may be sized and configured to cut through a wind turbine blade laterally.

In accordance with any of the embodiments disclosed herein, the wire saw may be configured to be mounted on the vehicle in a manner that allows for detachment of the wire saw.

In accordance with any of the embodiments disclosed herein, the wire saw system may have an opposing pulley positioned distal to the wind turbine blade from the wire saw, the pulley configured to receive a continuous abrasive wire from the wire saw and redirect the continuous abrasive wire back to the wire saw.

In accordance with any of the embodiments disclosed herein, the vehicle mounted wire saw may further comprise operating a wire saw system according to claim 4 or 5 to make a lateral cut through a wind-turbine blade, wherein the wind turbine blade is a used wind-turbine blade detached from a wind turbine.

In accordance with any of the embodiments disclosed herein, the vehicle mounted wire saw may further comprise making at least an additional lateral cut through the wind turbine blade in order to cut the wind-turbine blade into a total of three or more pieces.

In accordance with one embodiment of the present disclosure, a frame-mounted wire saw for cutting an object is provided. The frame-mounted wire saw generally includes a support frame assembly having a first beam having a first lengthwise channel; a second beam having a second lengthwise channel, the second beam positioned in a spaced apart configuration from the first beam; and a third beam positioned perpendicular to and bridging the first beam and the second beam, the third beam coupled to an end of the first beam and an end of the second beam. The frame-mounted wire saw further includes a first stationary pulley positioned near the coupling of the first and third beams and configured to receive and redirect a continuous abrasive wire from a wire saw housing; a second stationary pulley positioned near the coupling of the second and third beams and configured to receive and redirect the abrasive wire from the first stationary pulley; a third movable pulley coupled to a third bracket positioned on the second beam and configured to slide within the second lengthwise channel, the third movable pulley configured to receive and redirect the abrasive wire from the second stationary pulley; and a fourth movable pulley coupled to a fourth bracket positioned on the first beam and configured to slide within the first lengthwise channel along the length of the first beam, the fourth movable pulley configured to receive and redirect the abrasive wire from the third movable pulley, wherein the wire saw housing may be configured to redirect the abrasive wire toward the first stationary pulley.

In accordance with another embodiment of the present disclosure, a method of cutting an elongate object with a frame-mounted wire saw is provided. The method generally includes obtaining the elongate object; positioning the elongate object through the support frame assembly; directing a portion of the continuous abrasive wire at an axial speed from the wire saw housing to the first stationary pulley, the second stationary pulley, the third movable pulley, the fourth movable pulley, and back to the wire saw housing; sliding the third movable pulley and the forth movable pulley within the first and second lengthwise channels toward the elongate object; contacting a portion of the continuous abrasive wire between the third movable pulley and the fourth movable pulley to the elongate object; and sliding the third movable pulley and the forth movable pulley within the first and second lengthwise channels such that the continuous abrasive wire travels through the elongate object as the continuous abrasive wire moves axially.

In accordance with any of the embodiments disclosed herein, the frame-mounted wire saw may further include a fifth movable pulley coupled to the fourth bracket and configured to slide with the fourth movable pulley, the fifth movable pulley configured to receive the abrasive wire from the fourth movable pulley and direct the abrasive wire to the wire saw housing.

In accordance with any of the embodiments disclosed herein, the support frame assembly may further include a mobility system such that the frame-mounted wire saw is movable along the length of the object.

In accordance with any of the embodiments disclosed herein, the mobility system may be selected from the group consisting of wheels, continuous tracks, and skids.

In accordance with any of the embodiments disclosed herein, the frame-mounted wire saw may further include a fluid source for applying fluid to the abrasive wire.

In accordance with any of the embodiments disclosed herein, the first beam may further include a first upper section adjustable with respect to a first lower section, and the second beam may further include a second upper section adjustable with respect to a second lower section such that the height of the support frame assembly is adjustable.

In accordance with any of the embodiments disclosed herein, the adjustment of the height of the support frame assembly may be mechanically assisted.

In accordance with any of the embodiments disclosed herein, the first and second upper sections and the first and second lower sections may include a plurality of apertures for receiving a removable locking pin therethrough to set the support frame assembly to a fixed height.

In accordance with any of the embodiments disclosed herein, the object may be a wind turbine blade.

In accordance with any of the embodiments disclosed herein, the method may further include the step of adjusting the height of the support frame assembly to accommodate various sizes of the elongate object.

In accordance with any of the embodiments disclosed herein, the step of adjusting the height of the support frame assembly may be performed by adjusting a first upper section of the first beam with respect to a first lower section of the first beam, and adjusting a second upper section of the second beam with respect to a second lower section of the second beam following the step of obtaining the elongate object.

In accordance with any of the embodiments disclosed herein, adjusting the height of the support frame assembly may be mechanically assisted.

In accordance with any of the embodiments disclosed herein, the method may further include a fifth movable pulley coupled to the fourth bracket and configured to slide with the fourth movable pulley, wherein the step of directing a portion of the continuous abrasive wire may further includes directing the continuous abrasive wire from the fourth movable pulley to the fifth movable pulley prior to directing the continuous abrasive wire to the wire saw housing.

In accordance with any of the embodiments disclosed herein, the step of positioning the elongate object may further include moving the frame-mounted wire saw to a position along the length of the elongate object using a mobility system on the frame-mounted wire saw.

### DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIG. 1 is a perspective view of one representative embodiment of a frame-mounted wire saw in accordance with an aspect of the present disclosure;

FIG. 2 is a flow diagram describing a method for recycling wind turbine blades in accordance with one aspect of the present disclosure;

FIG. 3 is a flow diagram describing a method for cutting an object using the frame-mounted wire saw of FIG. 1;

FIG. 4 is an exemplary continuous abrasive wire for use with a vehicle-mounted wire saw;

FIG. 5 is a perspective view of one representative embodiment of a vehicle-mounted wire saw in accordance with an aspect of the present disclosure;

FIG. 6 is an exemplary wire saw for use with a vehicle-mounted wire saw;

FIG. 7 is a side view of the vehicle-mounted wire saw of FIG. 5, showing the vehicle-mounted wire saw cutting an object; and

FIG. 8 is a rear perspective view of the vehicle-mounted wire saw of FIG. 5, showing the vehicle-mounted wire saw cutting an object.

### DETAILED DESCRIPTION

The detailed description set forth below in connection with the appended drawings, where like numerals reference like elements, are intended as a description of various embodiments of the present disclosure and are not intended to represent the only embodiments. Each embodiment described in this disclosure is provided merely as an example or illustration and should not be construed as precluding other embodiments. The illustrative examples provided herein are not intended to be exhaustive or to limit the disclosure to the precise forms disclosed.

In the following description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “forward,” “rearward,” “front,” “rear,” “upward,” “downward,” “top,” “bottom,” “right hand,” “left hand,” “lateral,” “medial,” “in,” “out,” “extended,” etc. These references, and other similar references in the present application, are only to assist in helping describe and to understand the particular embodiment and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also in this regard, the present application may use the term “plurality” to reference a quantity or number.

The following description provides several examples that relate to using a frame-mounted wire saw for a sectioning step within a process for recycling used fiber composite (e.g., fiberglass) objects and products, such as wind turbine blades. However, the disclosed techniques and tools are not limited to recycling of wind turbine blades. With appropriate modifications, the disclosed methods, techniques, processes, and tools can be adapted for recycling other objects or materials. Suitable other objects or materials may include scrap material from manufacturing processes (e.g. fiber composite manufacturing processes), or other large objects formed entirely of recyclable materials or a combination of recyclable and non-recyclable materials, such as fiber composite boat hulls and hot tubs, among other objects and materials. Although the following description refers to embodiments for sectioning wind turbine blades using the frame-mounted wire saw, it should be appreciated that any suitable object or material may be sectioned using the aspects of the methods disclosed herein.

Generally described, a method for recycling wind turbine blades includes converting a whole wind turbine blade to an output material state that is useful for manufacturing other products, such as those used in construction of buildings, packaging, raw materials, and pellets, among other products. The recycling process is performed while tracking the progress and location of each wind turbine blade such that the direct source of the output material may be determined. The method includes sectioning the wind turbine blades using the embodiments described herein, crushing the wind turbine blade sections, tracking the progress of each blade through the process, and loading output materials into a suitable transportation vessel. Correlating each wind turbine blade to a quantity of output material provides several advantages, including various certifications of the material for uses with restricted or otherwise controlled products and materials, cost savings, and other advantages.

Given the immense size of wind turbine blades (e.g., 100+ feet long and 10+ feet wide), cutting a blade into smaller sections, such as for recycling according to the aspects disclosed herein, is a non-trivial problem to address. The length, width, curvature, and weight of wind turbine blades varies, depending on the size of the wind turbine, anticipated wind speeds, and other design considerations. For example, wind turbine blade sections may extend greater than 40 feet, have an effective width of 9 feet or greater, curve more than 6 feet from blade root to blade tip, and weigh more than 6,500 pounds per sectional piece.

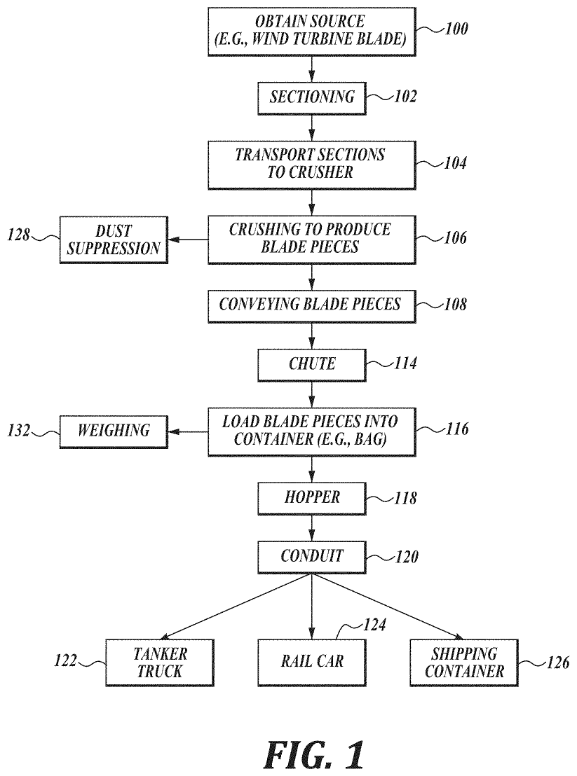

Referring to FIG. 1, a method for recycling a source object, such as a wind turbine blade, for providing raw output materials to be used in the production of new composite products, including fiber-reinforced plastics (FRP), is shown. The method generally includes obtaining the source object for recycling, sectioning the source object in to two or more sections using the embodiments disclosed herein, transporting the source object sections to the feed bin of a crushing machine, conveying the source object sections from the feed bin to a rotating crushing drum, crushing the source object sections, the crushing occurring in the rotating crushing drum to produce source object pieces, conveying the source object pieces to a chute configured to direct the source object pieces into a container, loading the source object pieces into the container, and loading the source object pieces into a transportation vessel. In some embodiments, the step of crushing the source object sections is performed with dust suppression measures to limit the environmental impact of the method. In other embodiments, a step of weighing the container having the source object pieces is performed prior to loading the source object pieces into a transportation vessel. The step of loading the source object pieces into a transportation vessel generally includes transporting the container to a loading hopper having an auger, unloading the blade pieces from the container into the hopper, and directing the blade pieces through a conduit with the auger to an outlet at the transportation vessel.

In block 100, a source object, such as a wind turbine blade, is obtained. In one embodiment, the wind turbine blade is sourced at a wind turbine farm where the blade has a specific effective life expectancy. At the end of the useful life, the blade may be selected for removal and replacement. After removal from the wind turbine tower, the methods disclosed herein are suitable for recycling the wind turbine blade into raw materials that are useful for creating new products. In some embodiments, the wind turbine blade is obtained and partially processed at the wind turbine farm. In other embodiments, the wind turbine blade is delivered to a facility for carrying out the steps of the method disclosed herein. In the embodiments disclosed herein, any number of blades may be processed simultaneously or in succession. For simplicity, the following description refers to a single wind turbine blade; however, applying the method to any number of wind turbine blades, or other source objects, is within the scope of the present disclosure.

After block 100, in block 102, the wind turbine blade is sectioned into two or more sections using embodiments disclosed herein, as will be described in greater detail below. After block 102, the wind turbine blade sections are transported to a feed bin of a crushing machine, block 104. In an embodiment, a crane having jaws, for example, can be used to hoist and load the feed bin, block 104. After block 104, the wind turbine blade sections are located in the feed bin for the crushing machine. The wind turbine blade sections are conveyed to a rotating crushing drum of the crushing machine at block 106. The crushing machine is configured to break the wind turbine blade sections into smaller blade pieces. At block 106, the step of crushing the wind turbine blade sections may include dust suppression at block 128 for environmental considerations, employee safety, and workplace cleanliness. From block 106, the method enters block 108. In block 108, the blade pieces coming from the crushing machine, block 106, are fed to an inclined conveyor to be transferred to a chute, block 114. From block 108, the method enters block 114, where the chute is positioned at the upper end of the inclined conveyor, block 108, and configured to direct the blade pieces into a container at block 116. From block 114, the method enters block 116, where the blade pieces are loaded into a container. From block 116, the method optionally enters block 132, where the container is weighed. From block 116, the method enters block 118, where the container is transported to a loading hopper for loading the blade pieces into a transportation vessel. In some embodiments, the loading hopper has an auger for directing the blade pieces through a conduit at block 120. In another aspect of the method for recycling a source object, such as a wind turbine blade, the method may include a step of grinding the blade pieces to produce blade particles.

Returning to block 102, the wind turbine blade is sectioned into two or more sections using embodiments disclosed herein. In some embodiments, the sectioning is performed at the wind turbine farm before the wind turbine blade is transported to a facility to perform the remaining steps of the method. The sectioning step may be performed by any suitable cutting tool, such as a wire saw having an endless loop abrasive cable, a circular saw, a grinder, an impact blade, a torch, or a waterjet. In embodiments where the sectioning is performed at the wind turbine farm, suitable environmental precautions may be taken. In one embodiment using the aforementioned wire saw, an oscillating or reciprocating cable is used.

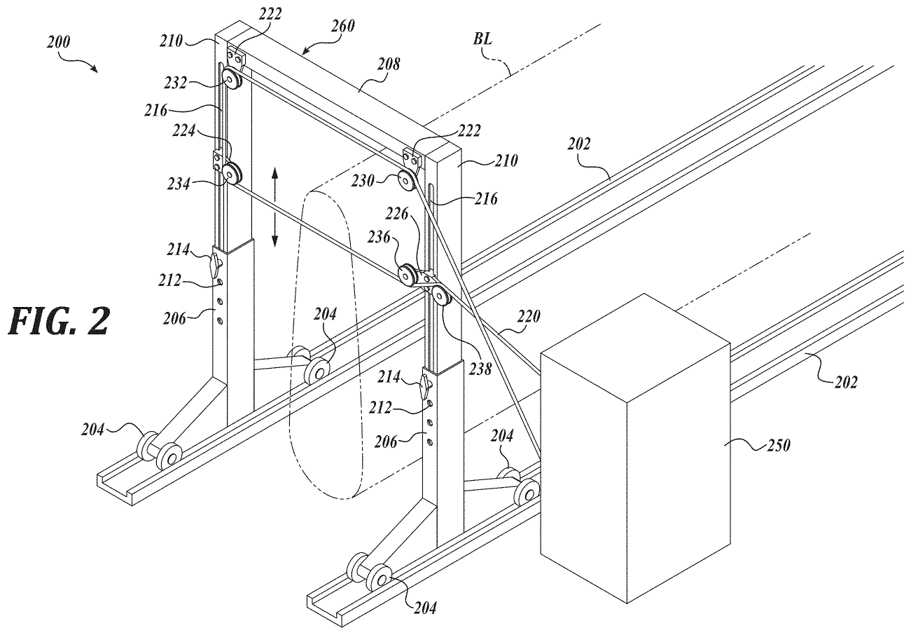

Turning to FIG. 2, a frame-mounted wire saw is shown. In some embodiments, the frame-mounted wire saw 200 generally includes a support frame assembly 260 having a crossbeam 208, vertical beams 210 supported by base stands 206. In some embodiments, the support frame assembly 260 includes a mobility system. In the illustrated embodiment, the mobility system includes elongate tracks 202 and wheels 204, such that the support frame assembly 260 is configured to travel along the elongate tracks 202. In other embodiments, the mobility system is any suitable system to allow the frame-mounted wire saw 200 to travel along the length of an object for cutting. In some embodiments, the mobility system includes wheels, continuous tracks, skids, and any other suitable system. In these embodiments, the mobility system may be mechanically assisted, for example, by a motor driving the wheels 204 to move the frame-mounted wire saw 200 along the elongate tracks 202.

The frame-mounted wire saw 200 includes a system of pulleys mounted on the support frame assembly 262 direct an abrasive wire 220 in a desired routing. The abrasive wire 220 is directed through a wire saw housing 250. The wire saw housing 250 generally includes a power source, a motor, gearing, controls, and other necessary components included in conventional wire saws. These components are not shown in the FIGURES for clarity. In some embodiments, a fluid may be applied to the abrasive wire 220 for cooling, dust suppression, cutting quality, and combinations thereof.

The pulley system and routing of the abrasive wire 220 will now be explained in greater detail. Although one exemplary pulley system configuration is shown and described, in other embodiments, any suitable pulley system configuration to direct the abrasive wire 220 through the desired routing is also within the scope of the present disclosure. In the illustrated embodiment, as the abrasive wire 220 travels away from the wire saw housing 250, the abrasive wire 220 interfaces a first pulley 230 fixedly mounted to the crossbeam 208 by a stationary bracket 222. The first pulley 230 is configured to redirect the abrasive wire 220 toward a second pulley 232 fixedly mounted to the crossbeam 208 by the stationary bracket 222. In other embodiments, the first and second pulleys 230 and 232 are mounted to the vertical beams 210. In further embodiments, the first and second pulleys 230 and 232 are mounted to any suitable portion of the support frame assembly 260.

The second pulley 232 is configured to redirect the abrasive wire 220 toward a third pulley 234 slidingly mounted to the vertical beam 210 by a first sliding bracket 224. The first sliding bracket 224 travels within a lengthwise channel 216 positioned on the vertical beam 210. The lengthwise channel 216 is configured to allow the first sliding bracket 224 to travel along the length of the vertical beam 210. Next, the third pulley 234 is configured to redirect the abrasive wire 220 toward a fourth pulley 236 slidingly mounted to the vertical beam 210 by a second sliding bracket 226 configured to travel within the lengthwise channel 216. In some embodiments, the abrasive wire 220 then travels back to the wire saw housing 250 to be redirected through the pulley system. In other embodiments, the fourth pulley 236 is configured to redirect the abrasive wire 220 toward a fifth pulley 238 slidingly mounted to the vertical beam 210 by the second sliding bracket 226. In this regard, the fifth pulley 238 and the fourth pulley 236 travel within the lengthwise channel 216 as a single unit. In other embodiments, the fifth pulley 238 is mounted to an independent bracket that may be stationary or slidable with respect to the vertical beam 210. In embodiments having the fifth pulley 238, the fifth pulley 238 is configured to direct the abrasive wire 220 back to the wire saw housing 250. In the illustrated configuration, the fifth pulley 238 supports the abrasive wire 220 as the abrasive wire 220 travels across the third and fourth pulleys 234 and 236. For different pulley system configurations, fewer than for pulleys or more than five pulleys may be used.

In some embodiments, the support frame assembly 260 is adjustable in height such that the frame-mounted wire saw 200 is capable of cutting objects in a variety of shapes and sizes. To adjust the support frame assembly 260, the base stands 206 may include apertures 212 and locking pins 214 which are inserted into the apertures 212 and corresponding apertures in the vertical beams 210 to lock the support frame assembly 260 in position. In some embodiments, the adjustment of the support frame assembly 260 is accomplished using a mechanically assisted system, such as a winch, hydraulics, pneumatics, cables, or any other mechanical assist.

In one example, the object to be cut is a wind turbine blade BL. In some embodiments, the frame-mounted wire saw 200 is translated along the length of the wind turbine blade BL by the mobility system including the elongate tracks 202 and wheels 204. In this regard, the frame-mounted wire saw 200 is positioned at the desired location for sectioning of the wind turbine blade BL. In other embodiments, the wind turbine blade BL is positioned such that the frame-mounted wire saw 200 is aligned with the desired location for sectioning of the wind turbine blade BL. In these embodiments, the mobility system of the frame-mounted wire saw 200 may be omitted in favor of a conveyor (not shown) to place the wind turbine blade BL in the desired position. In further embodiments, both the wind turbine blade BL and the frame-mounted wire saw 200 are mobile.

To cut the wind turbine blade BL, the abrasive wire 220 is directed through the pulley system of the frame-mounted wire saw 200. The third and fourth pulleys 234 and 236 are positioned such that the abrasive wire 220 is above the object to be cut. The third and fourth pulleys 234 and 236 are then slid down the lengthwise channel 216 such that the abrasive wire 220 contacts the object and starts to create a cut in the object. As the cut is formed in the object, the third and fourth pulleys 234 and 236 continue to slide down the lengthwise channel 216 until the abrasive wire 220 cuts through the object creating two sections of the object.

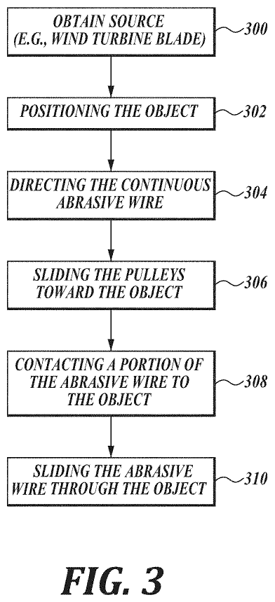

Turning now to FIG. 3, a method of cutting an object with the frame-mounted wire saw 200 will now be described. The method generally includes obtaining the elongate object at block 300; positioning the elongate object through the support frame assembly 260 at block 302; directing a portion of the continuous abrasive wire 220 at an axial speed from the wire saw housing 250 to the first stationary pulley 230, the second stationary pulley 232, the third movable pulley 234, the fourth movable pulley 236, and back to the wire saw housing 250 at block 304; sliding the third movable pulley 234 and the forth movable pulley 236 within the lengthwise channels 216 toward the elongate object at block 306; contacting a portion of the continuous abrasive wire 220 between the third movable pulley 234 and the fourth movable pulley 236 to the elongate object at 308; and sliding the third movable pulley 234 and the forth movable pulley 236 within the lengthwise channels 216 such that the abrasive wire 220 travels through the elongate object as the abrasive wire 220 moves axially at block 310.

In the embodiments disclosed herein, the support frame assembly is manufactured from materials and designed in a manner that supports the weight of the wire saw and any other components located on the support frame assembly. As an example, in one embodiment, the frame is made from 3″ to 4″ square tube steel. The size of the frame depends on the size of object to be cut.

In some embodiments, the wire saw is electrically powered and therefore requires a power source such as a generator (not shown). In order to accommodate the necessary electrical cord connecting the generator and the movable saw, a cord reel may be included on the wire saw housing 250. In these embodiments, the cord reel allows the stationary power source to power the saw as the power line is pulled out as the saw is operated down the track and recoiled as it is brought back to the start position. In an alternative embodiment, the wire saw is gas powered and no cord is needed. In yet a further embodiment, the saw is electrically powered and the generator to which the saw is connected is sufficiently small that it is mounted on the wire saw housing 250 and therefore travels with the support frame assembly, thereby obviating the need for a cord reel. In one embodiment, the support frame assembly includes a platform sized and configured to support the wire saw.

Using the disclosed frame-mounted wire saw, the approximate time to cut blade sections is on the order of 10-25 minutes per sectional piece, a large improvement over the present state of the art.

Diamond wire cutting (DWC) is the process of using abrasive wire of various diameters and lengths, impregnated with diamond dust of various sizes to cut through materials. As a result of the hardness of diamonds, this cutting technique can cut through almost any material that is softer than the diamond abrasive. The embodiments herein may be configured to cut a full wind turbine blade in two pieces in less than five minutes.

### Vehicle-Mounted Wire Saw for Cutting Wind-Turbine Blades

In one aspect, a wire saw configured to be mounted on a vehicle is provided, wherein the wire saw is sized and configured to cut through a wind-turbine blade laterally.

In one embodiment, the vehicle is a skid loader.

In one embodiment, the wire saw is configured to be mounted on the vehicle in a manner that allows for detachment of the wire saw.

In another aspect, a wire-saw system is provided that includes a vehicle and a wire saw according to the disclosed embodiments.

In one embodiment, the vehicle is a skid loader.

In another aspect, a method of cutting a wind-turbine blade is provided. In one embodiment, the method includes operating a wire-saw system according to the disclosed embodiments to make a lateral cut through a wind-turbine blade, wherein the wind-turbine blade is a used wind-turbine blade detached from a wind turbine.

In one embodiment the method further includes making at least an additional lateral cut through the wind-turbine blade in order to cut the wind-turbine blade into a total of three or more pieces.

The vehicle-mounted (or mountable) wire saw will now be discussed in further detail.

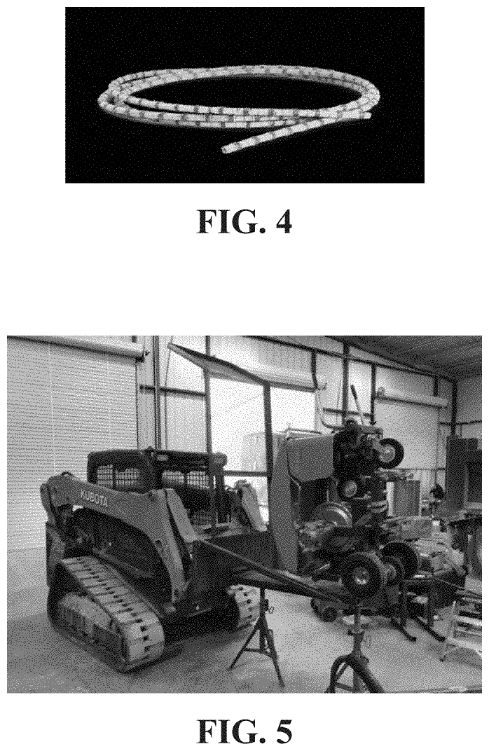

Diamond wire cutting (DWC) is the process of using wire of various diameters and lengths, impregnated with diamond dust of various sizes to cut through materials. Because of the hardness of diamonds, this cutting technique can cut through almost any material that is softer than the diamond abrasive. An exemplary continuous abrasive DWC wire is pictured in FIG. 4.

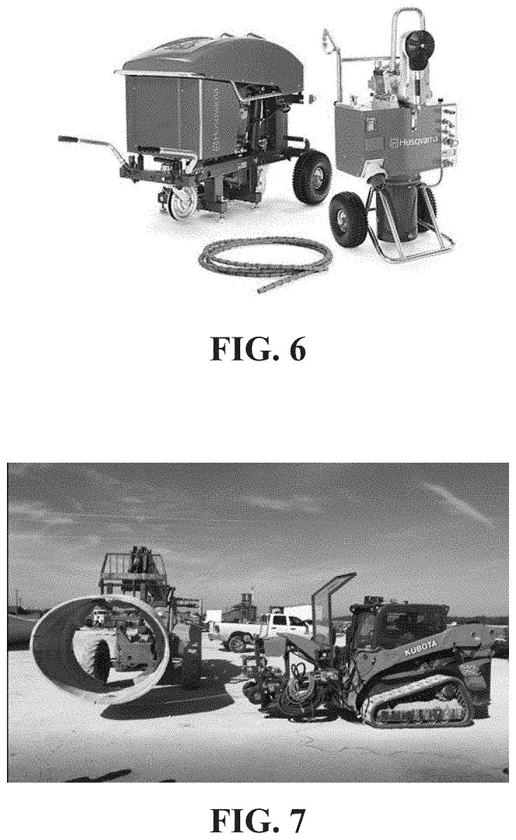

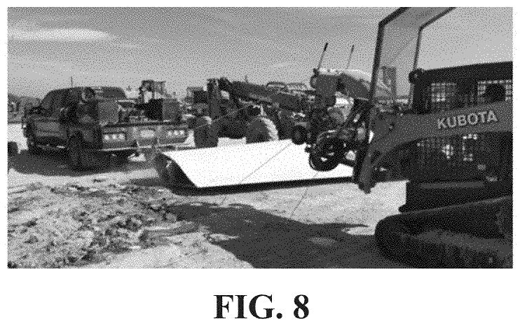

In the disclosed embodiments, a DWC saw (see FIG. 6) is configured to be mounted on a vehicle via a mechanical attachment. In one embodiment, which provides excellent maneuvering flexibility when cutting wind-turbine blades, the saw is mounted to a skid loader, as shown in FIGS. 5, 7, and 8.

In some embodiments, the skid loader is: designed to cut a full wind turbine blade in two pieces in less than five minutes; fast to keep pace with our outage and construction timeline; flexible to access restrictive jobsites without disrupting regular operations; precise to ensure surgical accuracy for retrofitting, reengineering and reconstruction wind turbine projects; agile, versatile, and compact wheeled machines that are convenient to use in multiple applications; getting around tight places with precision, and lifting sometimes doesn't require a big wheel loader, dozer, or rough terrain forklift. Skid steers are versatile enough to do all these tasks in tighter areas, maneuvering easy around the Wind Farms and OEM laydown areas; gives a more practical economical, time saving solution to do more than lifting; skid steer loaders are versatile enough to do what we need in tighter areas, easily maneuvering around wind farms and OEM laydown yards; a 1 ton truck can be used for hauling as opposed to a medium commercial flatbed; less cost for initial truck investment; no CDL requirements; no truck stops; fuel savings due to better mileage; the cutting unit itself is more maneuverable and can move from tower to tower on its own, leaving the trailer in the laydown yard; cost effective for large and other small jobs where it will be a tremendous benefit to us to be able to get to the blade quickly & easily with the saw as opposed to getting the blade to the saw; the skid loader has a quick disconnect bucket for back blading any ruts, etc.

A representative DWC wire saw is shown in FIG. 6 and includes the following: CS2512 Wire Saw; RC455 Valve Box and Remote; Requires external hydraulic power (Bobcat); Requires constant 12v power source inverter; Hydraulic Crimping Tool Kit; Connector Crimps; C1000 Wire; Offset Pulley Single.

As shown in FIGS. 5, 7, and 8 a skid loader-mounted wire saw is configured for cutting through a root section (top) and body (bottom) of a wind-turbine blade.

A skid loader-mounted wire saw operating procedure will now be described in detail. The purpose of the operating procedure is to provide consistent, safe, and efficient cutting and stacking of wind turbine blade pieces. The following method may be utilized in conjunction with any saw and/or any method of the present disclosure.

In some embodiments, the operating procedure comprises the below steps. In other embodiments, additional steps are included, variations of the below steps, or certain steps are omitted.

The operating procedure comprises:

1. Perform Job Safety Analysis. For example, the job safety analysis may be completed by all crew members and signed prior to start of work.

2. Inspect Equipment (e.g., Skid Loader). The inspection may include checking all fluids prior to operation, e.g., oil, water & hydraulics—low fluid levels can result in damage.

3. Inspect Saw (e.g., wire saw). The inspection may include checking wire alignment on all pulleys prior to each cut.

4. Attach pulley assembly to receiver on support vehicle.

5. The Skid Steer operator will keep eye contact with the saw operator and monitor all gauges while operating the saw.

6. Align truck and pulley on each side of cut.

7. Remove pulley from pulley assembly, attach wire and reinstall pulley to assembly.

8. Connect power source (e.g., 12-volt power source) from remote control to Smart Box.

9. Power-up Skid Loader.

10. When prompted from remote control, connect hydraulic hoses.

11. Turn water pump on and open red handled ball valve, verify water flow and 20 PSI on tank and at hoses by checking gauges.

12. At idle, engage hydraulics in skid steer by turning on axillary and start hydraulics on the joystick.

13. Tilt saw back towards the cab as directed by the saw operator.

14. Raise the saw platform as directed by the saw operator.

15. Engage wire tension (e.g., with remote control) to 700 PSI.

16. Engage engine speed (e.g., with remote control) to 2200 RPM.

17. Skid operator to bring Skid Loader to 2200 RPM when directed by saw operator.

18. Cut the object with the saw (e.g., cut the wind turbine). While cutting, monitor correct pulley operation and alignment to avoid damage to the assembly.

19. While cutting, monitor wire tension to maintain proper tension (e.g., 700 PSI).

20. While cutting, monitor heat on smart box, if excessively hot, shut down.

21. After cut, repeat steps 3 through 20 as necessary for additional cuts.

22. At the end of cutting procedures, turn hydraulics off and disconnect hoses.

23. At end of day remove remote control box and secure, check pulleys.

24. Clean saw daily once cutting operations end.

It will be appreciated that the foregoing steps may be performed in any suitable order. Certain steps may be omitted.

For the step of engaging wire tension with the remote control, in some embodiments, the wire tension is engaged to 700 PSI. In other embodiments, the wire tension is engaged in a range between 100 PSI and 5000 PSI. In another embodiment, the wire tension is engaged in a range between 500 PSI and 900 PSI. In another embodiment, the wire tension is engaged in a range between 600 PSI and 800 PSI. In further embodiments, the wire tension is engaged to at least 100 PSI.

For the step of engaging the speed with the remote control, in some embodiments, the speed is engaged at 2200 RPM. In other embodiments, the speed is engaged in a range between 500 RPM and 4000 RPM. In another embodiment, the speed is engaged in a range between 1000 RPM and 3000 RPM. In another embodiment, the speed is engaged in a range between 2000 RPM and 2400 RPM. In further embodiments, the speed is engaged to at least 500 RPM.

For the step of bringing the skid loader to a speed when directed, in some embodiments, the speed is 2200 RPM. In other embodiments, the speed is in a range between 500 RPM and 4000 RPM. In another embodiment, the speed is engaged in a range between 1000 RPM and 3000 RPM. In another embodiment, the speed is engaged in a range between 2000 RPM and 2400 RPM. In further embodiments, the speed is at least 500 RPM.

For the step of monitoring the wire tension while cutting, in some embodiments, the wire tension is monitored to remain at about 700 PSI. In other embodiments, the wire tension is monitored to remain in a range between 100 PSI and 5000 PSI. In another embodiment, the wire tension is engaged in a range between 500 PSI and 900 PSI. In another embodiment, the wire tension is engaged in a range between 600 PSI and 800 PSI. In further embodiments, the wire tension is monitored to remain at least at about 100 PSI.

It will be appreciated that other models of wire saws and vehicles besides a skid loader are encompassed by the present disclosure. Mounting a wire saw in order to increase mobility and allow positioning above the ground and in positions unreachable from ground-based wire saws. By attaching a wire saw to a vehicle (or robotic arm, etc.) many benefits are provided and the improved and efficient cutting of wind-turbine blades decreases the time required to recycle the wind-turbine blades.

One aspect relates to a method of recycling wind turbine blades. The method comprises cutting whole wind turbine blades into pieces; crushing or shredding the cut pieces to produce particles; bagging the particles; and unloading the bags into a hopper fitted with an auger to deliver the particles a transportation vehicle. In one embodiment of the method, bagging comprises holding a bulk bag underneath a chute hopper connected to an inclined conveyor. In one embodiment of the method, the inclined conveyor is fed wind turbine blade particles from a crusher or shredder. In one embodiment of the method, cutting comprises using a wire saw. In one embodiment of the method, the transportation vehicle is a tanker truck, a railcar, or a shipping container. In one embodiment of the method, the bags are unloaded from a discharge spout at the bottom side of the bags.

Another aspect relates to a system for recycling wind turbine blades. The system comprises a wire saw having an endless loop abrasive cable for cutting a wind turbine blade; a crusher having a feed bin with a conveyor leading to a rotating drum, wherein the feed bin is loaded with turbine blade sections; an inclined conveyor configured to be fed by the crusher; a bag beneath a chute hopper at the end of the inclined conveyor; and a front loader holding the bag beneath the chute hopper. In one embodiment of the system, the wire saw, crusher, inclined conveyor, and front loader are mobile.

Another aspect relates to a system for loading wind turbine particles. The system comprises a hopper filled with wind turbine blade particles, wherein the hopper has an auger on the inside; a tube ducting connected to a bottom of the hopper; and an electrically controlled load-out spout at the end of the tube ducting.

Another aspect relates to a system for tracking a wind turbine blade. The system comprises a backend server; a database containing wind turbine blade information, wherein the database communicates with the backend server; a first interface located at a wind farm, wherein the first interface communicates with the backend server; a second interface located at a wind turbine blade manufacturer, wherein the second interface communicates with the backend server; and a third interface located at a system administrator, wherein the third interface communicates with the backend server. One embodiment of the system further comprises a generator of forms.

Another aspect relates to a method for tracking and managing a wind turbine blade operating life. The method comprises providing a backend server; providing a database containing wind turbine blade information, wherein the database communicates with the backend server; providing a first interface located at a wind farm, wherein the first interface communicates with the backend server; providing a second interface located at a wind turbine blade manufacturer, wherein the second interface communicates with the backend server; and providing a third interface located at a system administrator, wherein the third interface communicates with the backend server. One embodiment of the method further comprises generating a form populated with wind turbine blade information.

Another aspect relates to a wire saw configured to be mounted on a vehicle, wherein the wire saw is sized and configured to cut through a wind-turbine blade laterally. Another aspect relates to a wire-saw system comprising a vehicle and a wire saw as disclosed. Yet another aspect relates to a method of cutting a wind-turbine blade, comprising operating a wire-saw system as disclosed, in order to make a lateral cut through a wind-turbine blade, wherein the wind-turbine blade is a used wind-turbine blade detached from a wind turbine.

Another aspect relates to a vehicle-mounted wire saw for cutting an object, comprising: a wire saw coupled to a vehicle and having a continuous abrasive wire; a wire saw feed pulley associated with the wire saw and configured to direct the continuous abrasive wire away from the wire saw; an opposing pulley positioned distal to the object from the wire saw, the pulley configured to receive and redirect the continuous abrasive wire from the wire saw feed pulley; and a wire saw receiving pulley associated with the wire saw and configured to receive the continuous abrasive wire from the opposing pulley and directing the continuous abrasive wire back to the wire saw feed pulley.

Another aspect relates to a vehicle-mounted wire saw wherein the support frame assembly further comprises a mobility system such that the vehicle-mounted wire saw is movable along the length of the object.

Another aspect relates to a vehicle-mounted wire saw wherein the vehicle is a skid loader.

Another aspect relates to a vehicle-mounted wire saw of any one of the preceding claims, further comprising a fluid source for applying fluid to the abrasive wire.

Another aspect relates to a vehicle-mounted wire saw wherein the adjustment of the height of the wire saw is through the loading system of the skid loader.

Another aspect relates to a vehicle-mounted wire saw wherein the object is a wind turbine blade.

Another aspect relates to a wire saw configured to be mounted on a vehicle, wherein the wire saw is sized and configured to cut through a wind turbine blade laterally.

Another aspect relates to a wire saw wherein the vehicle is a skid loader.

Another aspect relates to a wire saw wherein the wire saw is configured to be mounted on the vehicle in a manner that allows for detachment of the wire saw.

Another aspect relates to a wire saw system comprising a vehicle and a wire saw according to any of the preceding claims, the wire saw system having an opposing pulley positioned distal to the wind turbine blade from the wire saw, the pulley configured to receive a continuous abrasive wire from the wire saw and redirect the continuous abrasive wire back to the wire saw.

Another aspect relates to a method of cutting a wind-turbine blade, comprising operating a wire-saw system to make a lateral cut through a wind turbine blade, wherein the wind turbine blade is a used wind-turbine blade detached from a wind turbine.

Another aspect relates to a method, further comprising making at least an additional lateral cut through the wind-turbine blade in order to cut the wind turbine blade into a total of three or more pieces.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

The embodiments of the invention in which an exclusive property or privilege is claimed are defined as follows:

1. A method for using a vehicle-mounted wire saw for cutting an object, the method comprising:
coupling a wire saw having a continuous abrasive wire to a vehicle;
engaging a wire tension to between about 100 PSI and about 5000 PSI;
engaging a speed of an engine of the vehicle to between about 500 RPM and 4000 RPM; and
cutting the object with the wire saw.

2. The method of claim 1, wherein the wire tension is engaged to between 500 PSI and 900 PSI.

3. The method of claim 1, wherein the wire tension is engaged to between 600 PSI and 800 PSI.

4. The method of claim 1, wherein the wire tension is engaged to about 700 PSI.

5. The method of claim 1, wherein the speed of the engine is engaged to between 1000 RPM and 3000 RPM.

6. The method of claim 5, wherein the speed of the engine is engaged to between 2000 RPM and 2400 RPM.

7. The method of claim 6, wherein the speed of the engine is engaged to about 2200 RPM.

8. A method of cutting a wind-turbine blade, comprising operating a wire-saw system according to claim 1 to make a lateral cut through a wind turbine blade, wherein the wind turbine blade is a used wind-turbine blade detached from a wind turbine.

9. The method of claim 1, further comprising making at least an additional lateral cut through the wind-turbine blade in order to cut the wind turbine blade into a total of three or more pieces.

10. A method of cutting an elongate object with a skid loader-mounted wire saw, comprising:
obtaining the elongate object;
positioning the elongate object;
directing a portion of a continuous abrasive wire at an axial speed;
adjusting a height of forks of a skid loader to contact a portion of the continuous abrasive wire to the elongate object; and
adjusting the height of the forks of the skid loader such that the continuous abrasive wire travels through the elongate object as the continuous abrasive wire moves axially.

11. The method of claim 10, further comprising the step of tensioning the continuous abrasive wire to a tension between 100 PSI and 5000 PSI.

12. The method of claim 10, wherein the tension is between 500 PSI and 900 PSI.

13. The method of claim 12, wherein the tension is between 600 PSI and 800 PSI.

14. The method of claim 13, wherein the tension is about 700 PSI.

15. The method of claim 10, further comprising the step of adjusting an engine speed of the skid loader to between 500 RPM and 4000 RPM.

16. The method of claim 15, wherein the engine speed of the skid loader is adjusted to between 1000 RPM and 3000 RPM.

17. The method of claim 16, wherein the engine speed of the skid loader is adjusted to between 2000 RPM and 2400 RPM.

18. The method of claim 17, wherein the engine speed of the skid loader is adjusted to about 2200 RPM.
